(19) United States
(12) Patent Application Publication
(10) Pub. No.: US 2018/0362767 A1
(43) Pub. Date: Dec. 20, 2018

(54) Anthrapyridone Azo Dyes, Their Preparation And Use

(71) Applicant: DFI CHEM GmbH, Marly (CH)

(72) Inventors: Damien Moigno, Marly (CH); Kurt Baettig, Le Mouret (CH)

(21) Appl. No.: 15/780,511

(22) PCT Filed: Nov. 14, 2016
(86) PCT No.: PCT/EP2016/025145

§ 371 Date: May 31, 2018

(30) Foreign Application Priority Data
Dec. 2, 2015 (EP) 15020240.6

(51) Int. Cl. C09B 56/12; C09B 67/22; C09D 11/328; C09D 11/36

(52) U.S. Cl. CPC C09B 56/12; C09D 11/36; C09D 11/328; C09B 67/0046

(57) ABSTRACT

Azo anthrapyridone dye of general formula (III) wherein A, R₁, R₂, B, M and n are as described in the specification, are excellent magenta dyes for dyeing and printing of paper, other cellulose containing materials and textiles materials and, in particular, for the preparation of recording fluids for ink jet printing and for writing utensils.

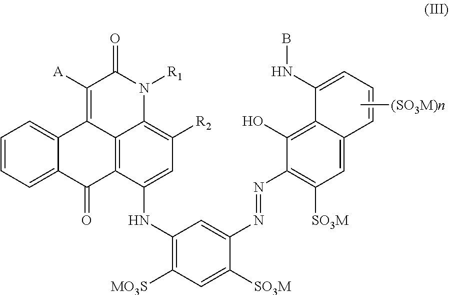

### FIELD OF THE INVENTION

The invention relates to novel Anthrapyridone azo dyes and their salts, a method of their preparation and their use in dying and printing operations. It also relates to liquid dye preparations containing at least one of these monoazo dyes, in particular to aqueous recording fluids for ink jet printing and for writing utensils.

### BACKGROUND OF THE INVENTION

Inkjet printing has replaced or complemented in many fields the classical methods of image reproduction. Although inkjet printing has reached a remarkable degree of maturity, further improvements are still necessary, in particular in the graphic and the photographic field. Modern inkjet printers need to furnish in these fields optimal prints on a wide variety of recording sheet such as polymer-based recording sheets or rapidly drying nanoporous recording sheets. In these fields, stability against light and oxidative gases (ozone, NOx), but also a large colour space (gamut) of the printed images is primordial. This can be achieved only by using a finely tuned system of recording liquids (respectively the dyes contains therein) adapted to these recording sheets.

Most of the commercially available magenta dyes that are used in recording liquids for inkjet printing do not satisfy all the necessary requirements in combinations with polymer-based and nanoporous recording sheets. The magenta dyes used nowadays do not have all required properties, such as a suitable hue, a very high brilliance (saturation), good light stability, good resistance against degradation by ozone, no dye aggregation on the surface of the recording sheet (“bronzing”), excellent diffusion fastness, and excellent solubility, and low viscosity and high color strength in the mainly aqueous recording liquids.

Although quite a number of different magenta dyes have already been proposed as dyes for inkjet printing, none meets all the necessary requirements.

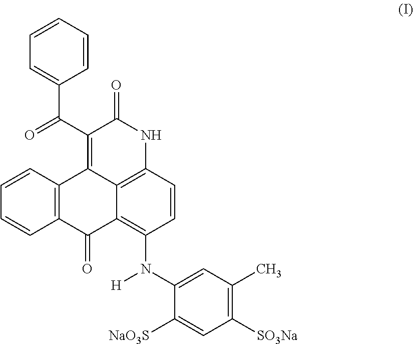

The magenta dyes of formula (I), described in patent application U.S. Pat. No. 6,152,969 (example Nr. 6) and the commercially available Bayscript® Magenta BB (Reactive Red 141) of formula (II) are representing the state of the art.

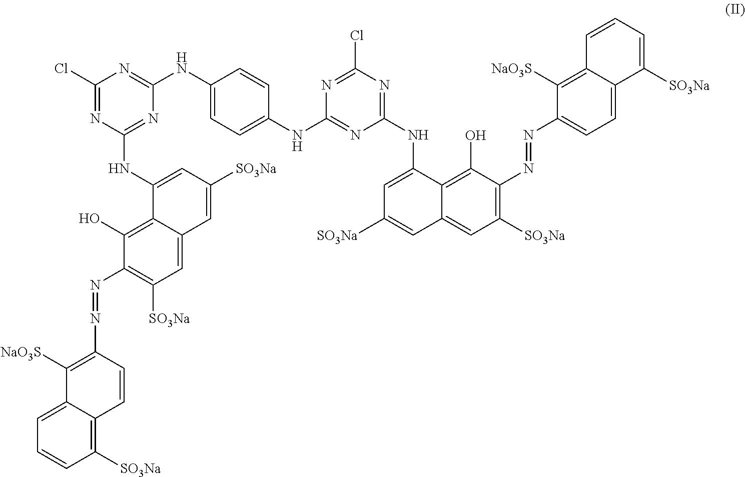

The dyes of type (I) do not satisfy all the required demands when used in formulation of recording liquids for inkjet printing that should provide magenta images or colorings with excellent color rendition (extended gamut) with elevated values of C* (L*C*h with C* being the value for the chroma), with a high saturation requesting less dye material for the same coloring properties as the state of the art and this on any type of recording medium as plain paper or coated paper, coated or uncoated, opaque or transparent synthetic materials, because these anthrapyridone dyes don't have good saturation or are too bluish.

The dyes of type (II) do not satisfy other required demands like good light stability and good resistance against degradation by ozone.

Additionally these dyes should also not induce a viscosity increase in the aqueous recording liquids. Dyes used in such recording liquids need to have a high solubility in the essential aqueous recording liquid, they have to penetrate into the recording sheet and should not show dye aggregation on the surface of the recording sheet (“bronzing”). They need to provide printed images having high brilliance, high optical density, good waterfastness, good light stability and good storage stability even under adverse conditions. They need to be stable in the recording liquid even when the recording liquid is stored for a long time under adverse conditions. Various types of compositions have been proposed as recording liquids. Typical recording liquids comprise one or more dyes or/and pigments, water, organic-co-solvents and other ingredients.

The recording liquids have to satisfy the following criteria:
(1) The recording liquid gives images of excellent quality of any type of recording sheet.
(2) The recording liquid gives images exhibiting good water fastness.
(3) The recording liquid gives images exhibiting good light stability.
(4) The recording liquid gives images exhibiting good stability against ozone degradation.
(5) The recording liquid gives images exhibiting excellent abrasion resistance.
(6) The recording liquid gives images exhibiting excellent storage stability under conditions of high temperature and humidity.
(7) The recording liquid does not clog jetting nozzles of the inkjet printers even when these are kept uncapped while recording is suspended for long periods.
(8) The recording liquid may be stored for long periods without deterioration of its quality.
(9) The physical properties of the recording liquids, such as viscosity, conductivity and surface tension are all within defined ranges well suited for the intended use.
(10) The recording liquid has to be non-toxic, non flammable and safe.

### SUMMARY OF THE INVENTION

An objective of the invention is to provide novel, well water-soluble anthrapyridone azo dyes having a pure magenta color with a broad range of hue from bluish to reddish and having excellent light stability and excellent resistance against degradation by ozone. In addition to this the dyes according to the invention present high color saturation and required lower quantities of colorant in recording fluids to achieve comparable printed optical density on inkjet papers as for the state of the art compounds.

A further objective of the invention is the provision of liquid dye preparations, in particular of recording liquids for inkjet printing, showing a spectrally unchanged hue on any type of recording sheet such as plain or coated paper, coated or uncoated, opaque or transparent synthetic materials.

A further objective of the invention is the provision of recording liquids satisfying all the requirements mentioned above.

### DETAILED DESCRIPTION OF THE INVENTION

The present invention relates to a novel anthrapyridone azo dye of general formula (III):

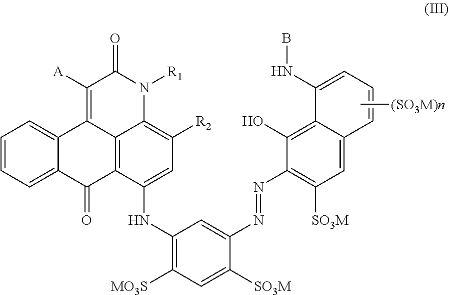

wherein
A represents a unsubstituted or substituted CO-phenyl group, where the substituents are selected from the group consisting of Cl, Br, OCH₃, SO₃M or represents a CO-thiophene group, a hydrogen atom, COOCH₃, COOCH₂CH₃, CN, or Phenyl group;
R₁ represents a hydrogen atom or a unsubstituted or substituted alkyl group having from 1 to 8 carbon atoms where the substituents are selected from the group consisting of OH, SO₃M, COOM;
R₂ represents a hydrogen atom or SO₃M
B represents a unsubstituted or substituted CO-aliphatic group having from 1 to 6 carbon atoms where the substituents are selected from the group consisting of Cl, Br, SO₃M, COOM and phenyl;
   or a unsubstituted or substituted CO-aromatic ring group where the substituents are selected from the group consisting of alkyl, alkoxy, Cl, Br, OH, COOM, CN, NO2, SO₃M and phenyl; or a CO-heterocyclic ring group;
   or a substituted or unsubstituted SO₂⁻aliphatic group having from 1 to 6 carbon atoms; or SO₂⁻aromatic ring group where the substituents are selected from the group consisting of alkyl, alkoxy, Cl, Br, CN, NO2, SO₃M and phenyl; or SO₂⁻ heterocyclic ring group;
   or represents a moiety of formula C

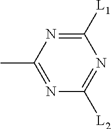

Wherein L₁ and L₂ independently represents OH, Cl, alkoxy having from 1-6 carbon atoms, substituted thioalkyl having from 1-6 carbon atoms where the substituents are selected from the group consisting of OH, COOM and SO₃M; or NR₆R₇ where R₆R₇ independently represents H, substituents having from 1-6 carbon atoms where the substituents are selected from the group consisting of OH, COOM and SO₃M,
   or represents a moiety of formula D

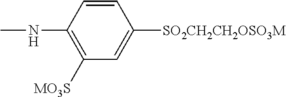

or represents a moiety of formula E,

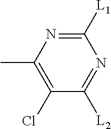

Wherein L₁ and L₂ independently represents OH, Cl, alkoxy having from 1-6 carbon atoms, substituted thioalkyl having from 1-6 carbon atoms where the substituents are selected from the group consisting of OH, COOM and SO₃M; or NR₆R₇ where R₆R₇ independently represents H, substituents having from 1-6 carbon atoms where the substituents are selected from the group consisting of OH, COOM and SO₃M.
M represents hydrogen, a metal cation or an ammonium cation, optionally substituted by one or more alkyl groups or substituted alkyl groups or hydroxyalkoxyalkyl groups each having from 1 to 18 carbon atoms.
and
n is 0 or 1 and SO₃M is in position 3 or 4

Preferred are anthrapyridone azo dyes, wherein A and M are as defined above
R₁ represents hydrogen or a methyl group
R₂ represents a hydrogen
B represents a unsubstituted or substituted CO-aliphatic or
   CO-aromatic or CO-heterocyclic ring group, a substituted or unsubstituted SO₂⁻aliphatic or SO₂⁻aromatic or SO₂⁻heterocyclic ring group where the substituents are selected from the group consisting of alkyl, alkoxy, Cl, Br, OCH₃, SO₃M and phenyl
and
n is 1 and SO₃M is in position 3 or 4

Particularly preferred are anthrapyridone azo dyes, wherein A, R₁, R₂, B and M are defined as above,
and
n is 1 and SO₃M is in position 4.

The prepared dyes of general formula (III) are listed in Table 1 wherein M is specified.

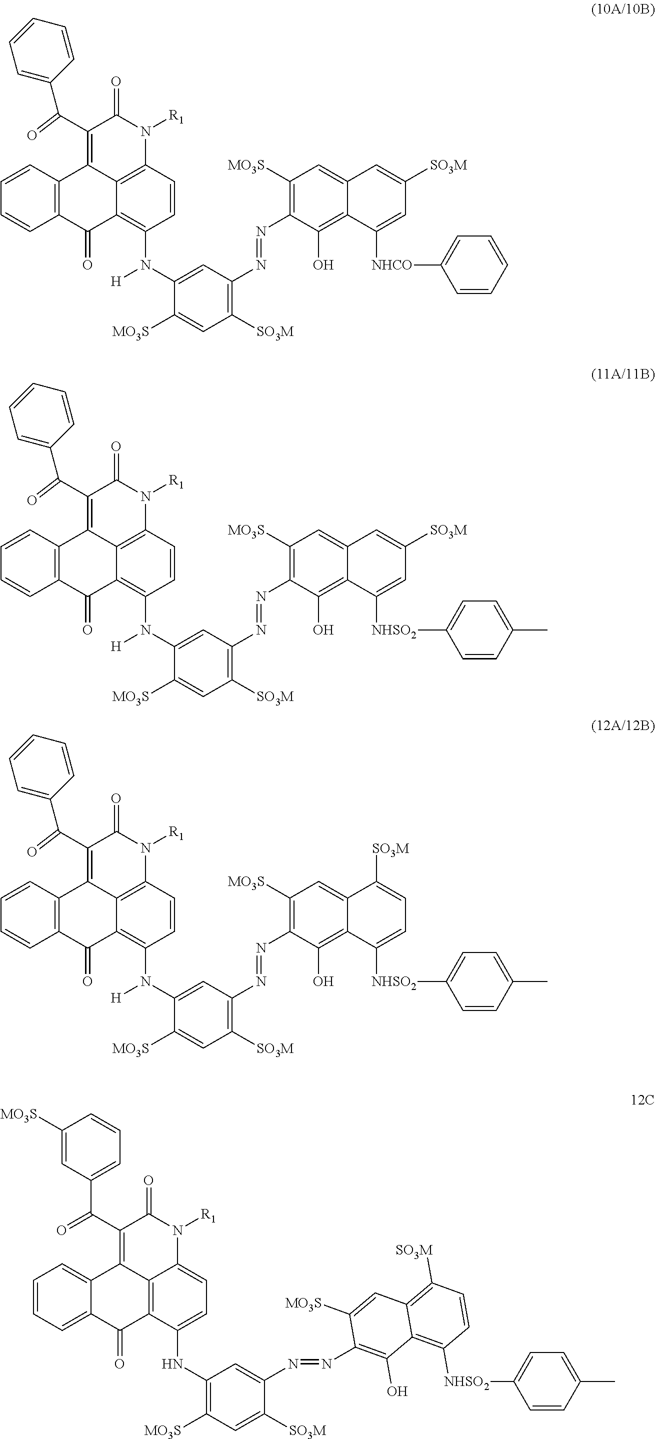

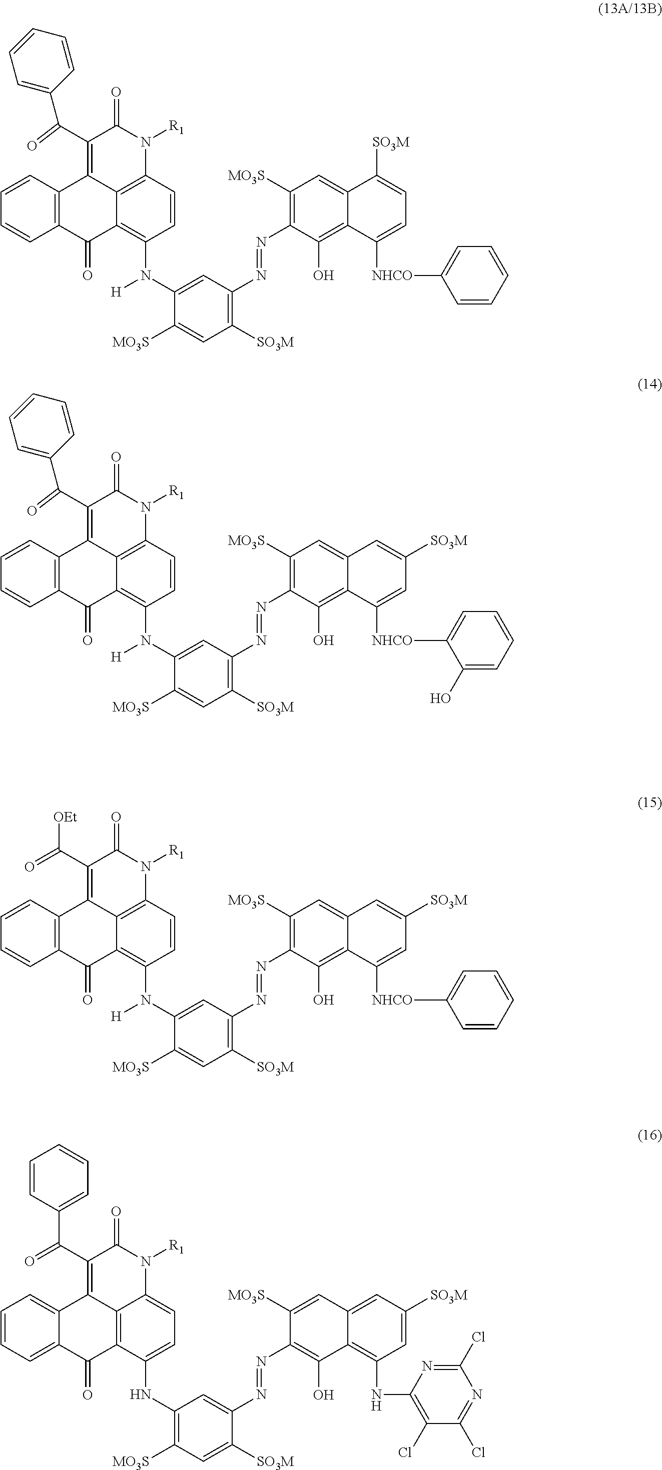

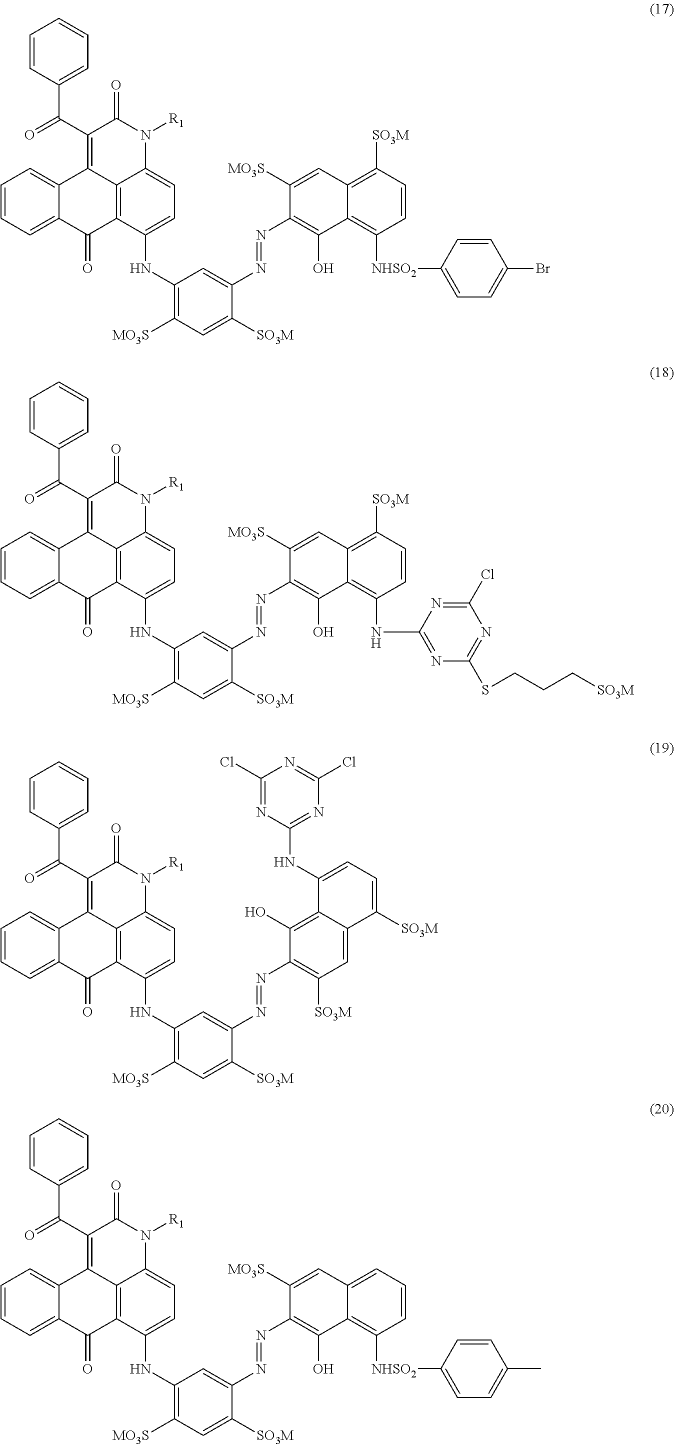

The prepared dyes of general formula (III) are listed in table 1 together with the position of their absorption maximum in aqueous solution (buffer pH 7.0)

TABLE 1

| Dye Nr. | R1 | M | λₘₐₓ (nm) |
|---|---|---|---|
| 10A | H | Na | 546 |
| 10B | CH₃ | Na | 546 |
| 11A | H | Na | 539.5 |
| 11B | CH₃ | Na | 541 |
| 12A | H | Na | 538.5 |
| 12B | CH₃ | Na | 537 |
| 12C | CH3 | Na | 534 |
| 13A | H | Na | 546 |
| 13B | CH₃ | Na | 544 |
| 14 | H | Na | 547 |
| 15 | H | Na | 546 |
| 16 | CH₃ | Na | 552 |
| 17 | CH₃ | Na | 537.5 |
| 18 | CH₃ | Na | 543.5 |
| 19 | CH₃ | Na | 543 |
| 20 | CH₃ | Na | 535 |

The compounds of general formula (III) may be in the free acid form or in the form of inorganic salts thereof.

Preferably, they are in the form of their alkali or ammonium salts, wherein the ammonium cation may be substituted.

Examples of such substituted ammonium cations are 2-hydroxyethylammonium, bis-(2-hydroxyethyl)-ammonium, tris-(2-hydroxyethyl)-ammonium, bis-(2-hydroxyethyl)-methyl-ammonium, tris-[2-(2-methoxyethoxy)-ethyl]-ammonium, 8-hydroxy-3,6-dioxaoctylammonium and tetraalkylammonium such as tetramethylammonium oder tetrabutylammonium.

The invention does not only relate to a pure anthrapyridone azo dye of general formula (III), but also to mixtures of these compounds.

The invention also relates to a method of preparation of the dyes of general formula (III) according to the invention, characterized by the fact that a β-ketoester of general formula (IV)

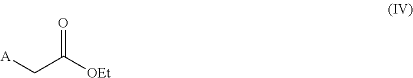

wherein A is defined as above, is reacted with a compound of formula (V),

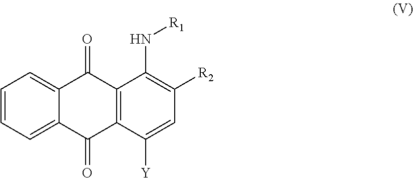

wherein R₁ and R₂ are defined as above and Y represents chloro, bromo or another leaving group, under conditions that the anthrapyridone of formula (VI) are formed,

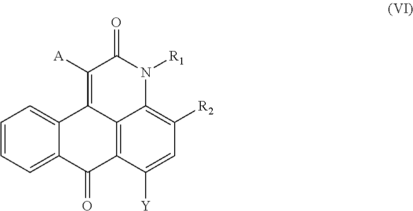

The anthrapyridone of general formula (VI), wherein A, R₁ and R₂ are defined as above, is reacted with m-Phenylenediamine under conditions that the anthrapyridone dye of general formula (VII) is formed.

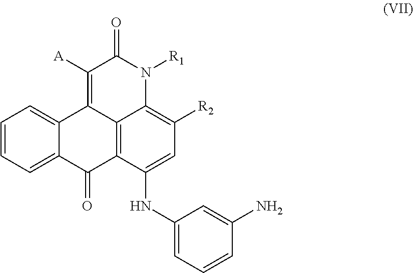

The anthrapyridone of general formula (VII), wherein A, R₁ and R₂ are defined as above is reacted with sulfamic acid or Oleum under conditions that the dye is sulfonated and leading to an anthrapyridone dye of general formula (VIII).

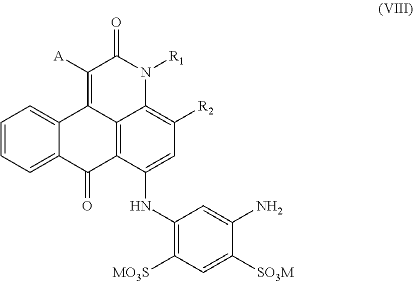

The anthrapyridone dye of general formula (VIII), wherein A, R₁, R₂ and M are defined as above is diazotized and reacted with a compound of general formula (IX)

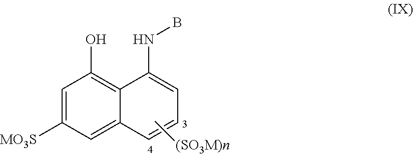

where M, B and n are defined as above, under conditions that the anthrapyridone azo dye of general formula (III) according to the invention is formed.

The anthrapyridone azo dye of general formula (III) according to the invention is used for dying cellulose containing materials, nanoporous inkjet paper, plain paper, cotton, viscose, leather, aluminum plates and wool to provide dyed materials with good water fastness and light stability.

All methods well known in the textile and paper industries for dyeing with substantive dyes may be used, in particular for the bulk or surface treatment of sized or unsized paper. The dyes may also be used in the dyeing of yarns and piece goods of cotton, viscose and linen by the exhaustion process from a long liquor or in a continuous process.

The invention furthermore relates to liquid dyes preparations comprising at least one anthrapyridone azo dye of general formula (III). The use of such liquid dye preparations is particularly preferred for paper dyeing. Such stable, liquid, preferably aqueous, concentrated dye preparations may be obtained by using methods well known in the art, preferably by dissolving in suitable solvents.

The possibility of preparation of such stable, aqueous, concentrated preparations in the course of dye synthesis itself, without intermediate isolation of the dye, for example after a desalting step by nanofiltration of the reaction solution, is of particular advantage.

The dye or mixture of dye of general formula (III) are excellent dyes for the preparation of recording liquids for inkjet printing.

The anthrapyridone azo dye of general formula (III) according to the invention may be combined well with other magenta dyes, in particular with the dyes described in patent applications EP 0,754,207, EP 1,160,291, EP1,219,682 and EP 1,403,328.

In ink sets for inkjet printing, the anthrapyridone azo dye of formula (III) according to the invention, together with yellow dyes, as described for example in patent applications EP 0,755,984 and EP 1,882,723, and cyan dyes, as described for example in patent application EP 1,867,685 span an optimal color space. Further, the dye triple used in recording liquids have a similar resistance against degradation by light and ozone.

A typical recording liquid comprises one or more of the anthrapyridone azo dyes according to the invention in a liquid aqueous medium. The recording liquid contains from 0.5 percent by weight to 20 percent by weight, preferably from 0.5 percent by weight to 8 percent by weight, of these anthrapyridone azo dyes, based on the total weight of the recording liquid. The liquid medium is preferably water or a mixture of water and water-miscible organic solvents. Suitable solvents are described for example in U.S. Pat. Nos. 4,626,284, 4,703,113 and 4,963,189 and in patent applications GB 2,289,473, EP 0,425,150 and EP 0,597,672.

The present invention will be illustrated in more details by the following examples without limiting the scope of the claimed compounds in any way.

### EXAMPLES

### Example 1

the anthrapyridone dye (10A) of table 1, wherein R₁═H, M is Na was prepared in the following way:

Preparation of the Brominated Anthrapyridone Compound of Formula (X):

75.5 g (0.25 Mol) 1-Amino-4-bromanthraquinone (available from Sigma-Aldrich GmbH, Buchs, Switzerland), 59.5 g (0.3 Mol) of Ethylbenzoylacetate 97% (available from Sigma-Aldrich GmbH, Buchs, Switzerland), 3.9 g (0.04 Mol) of potassium acetate and 125 ml 1,2-Dichlorobenzene were stirred in a nitrogen atmosphere for 22 hours at a temperature of 140° C. About 12 ml Ethanol were removed from the reaction mixture by distillation.

Subsequently, the resulting dispersion was cooled down to room temperature, the product was sucked off, well washed with ethanol and dried.

70.2 g of the product of formula (X) were obtained in this way.

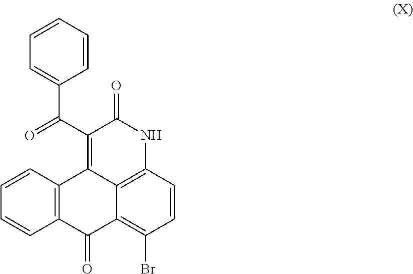 [SMILES: O=C(c1ccccc1)c1c2c3c(c(Br)ccc3[nH]c1=O)C(=O)c1ccccc1-2]

Preparation of the Dye of Formula (XI):

34.4 g (0.08 Mol) of the Bromoanthrapyridone of formula (X), 17.5 g (0.16 Mol) of Phenylenediamine 99% (available from Sigma-Aldrich GmbH, Buchs, Switzerland), 0.8 g of Copper(II)-acetate and 100 ml of N-Methylpyrrolidone were stirred in a nitrogen atmosphere for 48 hours at a temperature of 140° C.

Afterwards, the mixture was cooled down to room temperature and 200 ml of water were added to the reaction mixture. The precipitated product was collected by filtration and well washed with water. After drying 41.7 g of the dye of formula (XI) were obtained.

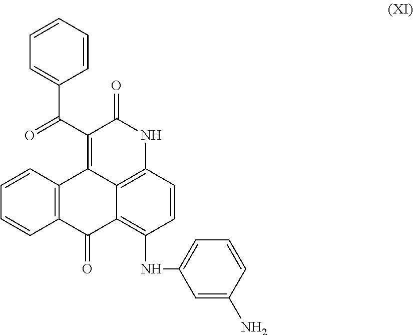 [SMILES: Nc1cccc(Nc2ccc3[nH]c(=O)c(C(=O)c4ccccc4)c4c3c2C(=O)c2ccccc2-4)c1]

Sulfonation of the Anthrapyridone Dye of Formula (XI):

A) Sulfonation of the Anthrapyridone Dye of Formula (XI) in NMP Using Sulfamic Acid:

15.7 g (0.03 Mol) of the Anthrapyridone of formula (XI), 14.6 g (0.15 Mol) of Sulfamic acid and 50 ml of N-Methylpyrrolidone were stirred in a nitrogen atmosphere for 3 hours at a temperature of 120° C. The re action mixture was then cooled down to room temperature and 100 ml of Isopropanol were added to precipitate the product.

The precipitated sulfonated dye of formula (VIIIA) was then sucked off and washed with Isopropanol. The purification of the crude product was performed by dissolving the obtained solid in 100 ml water, stirring under reflux and the obtained solution was clear filtrated. The product was then precipitated by the addition of 15 g of Sodium chloride, sucked off. After drying 16.1 g of the product of formula (VIIIA) were obtained.

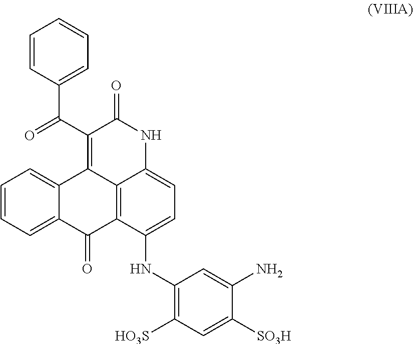 [SMILES: Nc1cc(Nc2ccc3[nH]c(=O)c(C(=O)c4ccccc4)c4c3c2C(=O)c2ccccc2-4)c(S(=O)(=O)O)cc1S(=O)(=O)O]

or

B) Sulfonation of the Anthrapyridone Dye of Formula (XI) in Oleum:

The sulfonation of the anthrapyridone of formula (XI) was carried out in 20% oleum and sulfuric acid 98% at 90° C. for 2 h. The reaction mixture was drowned in crushed ice and the product of formula (VIIIB) was precipitated with NaCl.

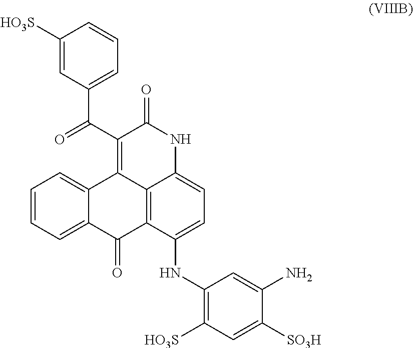 [SMILES: Nc1cc(Nc2ccc3[nH]c(=O)c(C(=O)c4cccc(S(=O)(=O)O)c4)c4c3c2C(=O)c2ccccc2-4)c(S(=O)(=O)O)cc1S(=O)(=O)O]

Preparation of the Dye (10A)

1.3 g (2 mMol) of the Anthrapyridone dye of formula (VIIIA), were dissolved in 20 ml distilled water. The obtained solution was cooled down to a temperature between 0° C. and 5° C. and 1.5 ml of an aqueous solution of Hydrochloric acid (37%) were added to the solution under stirring and 0.5 ml of an aqueous solution (4N) of Sodium nitrite were slowly added keeping the temperature between 0° C. and 10° C. The reaction mixture was then stirred 1 hour at this temperature. The excess of nitrous acid was removed by reaction of Sulfamic acid.

The diazonium suspension was then slowly added to 0.85 g of Benzoyl-H-acid (CAS 117-46-4) of formula (IX) in 10 ml distilled water between 5-10° C. under stirring and by keeping the pH to a value of 5.0 to 8.0 by a simultaneous addition of Sodium hydroxide (1N). The addition terminated, stirring was continued for 2 hours at a temperature between 0° C. and 5° C. and then allowed to warm up to room temperature. After 2 hours the dye solution was clear filtrated and then precipitated by the addition of 4.0 g of Sodium acetate and filtered off. The raw dye was purified with 30 ml of an aqueous solution (70%) of Ethanol. After drying, 1.2 g of dye (10A) in the form of its sodium salt were obtained.

### Example 2

Anthrapyridone azo dye (10B) of table 1, wherein M is Na was prepared as in example 1. However in the preparation of (X) 1-Methylamino-4-bromoanthraquinone (CAS 128-93-8) was used in place of 1-Amino-4-bromoanthraquinone (CAS 81-62-9) as in example 1.

### Example 3

### Preparation of Anthrapyridone Azo Dye (11A) of Table 1

1.3 g (2 mMol) of the Anthrapyridone dye of formula (VIIIA), were dissolved in 20 ml distilled water. The obtained solution was cooled down to a temperature between 0° C. and 5° C. and 1.5 ml of an aqueous solution of Hydrochloric acid (37%) were added to the solution under stirring and 0.5 ml of an aqueous solution (4N) of Sodium nitrite were slowly added keeping the temperature between 0° C. and 10° C. The reaction mixture was then stirred 1 hour at this temperature. The excess of nitrous acid was removed by reaction of Sulfamic acid.

Synthesis of Tosyl-H-Acid of Formula (IX):

42.6 g of H-Acid (75%, MW 319.3g/mol, CAS 90-20-0) 0.1 mol were suspended with 40 ml water in a flask. The grey suspension was heated to 70° C. and the pH was adjusted to a value of 3 with 10.8 g of a 30% solution of sodium hydroxide. 22.3 g of p-Toluenesulfonylchloride 99% were slowly added to the dark solution maintaining the pH to a value of 3 using 21 g of a 30% solution of sodium hydroxide. The pH was then set to a value of 6 using 20 g of sodium acetate. The reaction mixture was then concentrated in the rotary evaporator and cooled down to room temperature. The obtained product was collected by filtration and washed with 20 ml Methanol. Tosyl-H-Acid was then obtained in a 77% yield.

The diazonium suspension was then slowly added to 0.85 g of Tosyl-H-acid in 10 ml distilled water between 5-10° C. under stirring and by keeping the pH to a value of 5.0 to 8.0 by a simultaneous addition of Sodium hydroxide (1N). The addition terminated, stirring was continued for 2 hours at a temperature between 0° C. and 5° C. and then allowed to warm up to room temperature. After 2 hours the dye solution was clear filtrated and then precipitated by the addition of 4.0 g of Sodium acetate and filtered off. The raw dye was purified with 30 ml of an aqueous solution (70%) of Ethanol. After drying, 1.1 g of dye (11A) in the form of its sodium salt were obtained.

### Example 4

Anthrapyridone azo dye (11B) of table 1, wherein M is Na was prepared as in example 3. However in the preparation of (X) 1-Methylamino-4-bromoanthraquinone (CAS 128-93-8) was used in place of 1-Amino-4-bromoanthraquinone (CAS 81-62-9) of example 3.

### Example 5

Anthrapyridone azo dye (12A) of table 1, wherein M is Na was prepared as in example 3. However for compound of formula (IX) Tosyl-K-Acid was used in place of Tosyl-H-Acid of example 3. For the synthesis of Tosyl-K-Acid, K-Acid (CAS 130-23-4) was used in place of H-Acid (CAS 90-20-0) of example 3.

### Example 6

Anthrapyridone azo dye (12B) of table 1, wherein M is Na was prepared as in example 5. However in the preparation of (X) 1-Methylamino-4-bromoanthraquinone (CAS 128-93-8) was used in place of 1-Amino-4-bromoanthraquinone (CAS 81-62-9).

### Example 7

Anthrapyridone azo dye (12C) of table 1, wherein M is Na was prepared as in example 1. However for the preparation of (VIIIB) 1-Methylamino-4-bromoanthraquinone (CAS 128-93-8) was used in place of 1-Amino-4-bromoanthraquinone (CAS 81-62-9) and for formula (IX) Tosyl-K-Acid was used in place of Benzoyl-H-acid of example 1.

### Example 8

Anthrapyridone azo dye (13A) of table 1, wherein M is Na was prepared as in example 1. However for compound of formula (IX) Benzoyl-K-Acid was used in place of Benzoyl-H-acid of example 1.

### Example 9

Anthrapyridone azo dye (13B) of table 1, wherein M is Na was prepared as in example 8. However in the preparation of (X) 1-Methylamino-4-bromoanthraquinone (CAS 128-93-8) was used in place of 1-Amino-4-bromoanthraquinone (CAS 81-62-9) of example 8.

### Example 10

Anthrapyridone azo dye (14) of table 1, wherein M is Na was prepared as in example 1. However for compound of formula (IX) 4-(2-Hydroxybenzamino)-5-hydroxynaphthalene-2,7-disulfonic acid was used in place of Benzoyl-H-Acid of example 1.

### Example 11

Anthrapyridone azo dye (15) of table 1, wherein M is Na was prepared as in example 1. However, Ethyl malonyl chloride (CAS 36239-09-5) was used in place of Ethylbenzoylactetate (CAS 94-02-0) in the preparation of (X) of example 1.

### Example 12

Anthrapyridone azo dye (16) of table 1, wherein M is Na was prepared as in example 1. However in the preparation of (X) 1-Methylamino-4-bromoanthraquinone (CAS 128-93-8) was used in place of 1-Amino-4-bromoanthraquinone (CAS 81-62-9) and for compound of formula (IX) 4-Hydroxy-5-[(2,5,6-trichloropyrimidin-4-yl)amino]naphthalene-2,7-disulfonic acid was used in place of Benzoyl-H-acid of example 1.

4-Hydroxy-5-[(2,5,6-trichloropyrimidin-4-yl)amino]naphthalene-2,7-disulfonic acid was synthesized according to JP 2010 116489 A using 2,4,5,6-tetrachloropyrimidine and K-Acid in place of cyanuric chloride and H-Acid of compound 15.

### Example 13

Anthrapyridone azo dye (17) of table 1, wherein M is Na was prepared as in example 1. However in the preparation of (X) 1-Methylamino-4-bromoanthraquinone (CAS 128-93-8) was used in place of 1-Amino-4-bromoanthraquinone (CAS 81-62-9) of example 1. Compound of general formula (IX) was synthesized using 4-Bromosulfonylchloride and K-Acid in place of p-toluenesulfonylchloride and H-Acid of example 1.

### Example 14

Anthrapyridone azo dye (18) of table 1, wherein M is Na was prepared as in example 1. However for compound of formula (IX) 4-({4-Chloro-6-[(3-sulfopropyl)thio]-1,3,5-triazin-2-yl}amino)-5-hydroxynaphthalene-1,7-disulfonic acid was used in place of Benzoyl-H-acid of example 1.

4-({4-Chloro-6-[(3-sulfopropyl)thio]-1,3,5-triazin-2-yl}amino)-5-hydroxynaphthalene-1,7-disulfonic acid was synthesized as example 2, formula (2), part (a) and (b) of US patent 2008/0207881 A1 using K-Acid (CAS 130-23-4) and sodium 3-mercaptopropane sulphonate (CAS 17636-10-1) in place of H-Acid and thioglycolic acid.

### Example 15

Anthrapyridone azo dye (19) of table 1, wherein M is Na was prepared as in example 1. However for compound of formula (IX) 4-[(4,6-Dichloro-1,3,5-triazin-2-yl)amino]-5-hydroxynaphthalene-1,7-disulfonic acid was used in place of Benzoyl-H-Acid of example 1.

4-[(4,6-Dichloro-1,3,5-triazin-2-Aamino]-5-hydroxynaphthalene-1,7-disulfonic acid was synthesized as compound (15) of Patent JP 2010 116489 A using K-Acid (CAS 130-23-4) in place of H-Acid (CAS 90-20-0).

### Example 16

Anthrapyridone azo dye (20) of table 1, wherein M is Na was prepared as in example 3. However for compound of formula (IX) 4-Hydroxy-5-{[(4-methylphenyl)sulfonyl]amino}naphthalene-2-sulfonic acid was used in place of Tosyl-H-acid of example 3.

### Example 17

### Preparation of a Recording Liquid

The present invention, as far as it relates to recording liquids, is illustrated by the following examples using the anthrapyridone azo dyes (10A) to (19) according to the invention and dyes representing the state of the art.

For each dye, 10 g of recording liquid were prepared by heating the necessary amount of dye (2.0 to 4.5g), ethylene glycol (0.6g), propylene-1,2-glycol (0.3g), 1-methyl-2-pyrrolidone (0.3g), an aqueous solution (50%) of Olin® 10G (available from Arch Chemicals Inc., Norwalk, USA) (0.03g), Surfinol® 465 (available from Air Products and Chemicals Inc., Allentown, USA) (0.03g) and a solution of the biocide Mergal® K10N (available from Riedel-de-Haën, Seelze, Germany) (0.01 g) together with water at a temperature of 50° C. under stirring for approximately 1 hour. The resulting solution was cooled down to a temperature of 20° C, its value of pH was adjusted to 7.5 with an aqueous solution of sodium hydroxide (1N). The solution was passed through a Millipore® filter of 0.5 μm pore diameter. The dye quantity was adjusted in such a way that the optical density of the printed images was more and less similar for all tested dyes.

Examples of Application of Recording Liquids:

The inks prepared were then applied using an inkjet printer of the type Canon iP4000 Pixma on the following recording materials
1) ILFORD Premium Plus Instant Dry Glossy Paper RC (inkjet recording sheet)
2) START® paper (uncoated paper)

For printing the magenta square patches, the ink was filled in an empty cartridge and placed in the yellow channel of the printer settings so that only the pure ink was printed. In terms of software, Photoshop® 4 (Adobe Systems, Inc.) was used. There, the printer settings were set to “paper photo pro”, quality was set to “high”, color setting parameters to “manual” option. Regarding the picture type, the option “none” was chosen. A yellow patch was designed in Photoshop® and printed with the magenta ink in the yellow cartridge. The obtained colored patches were used for the determination of the light stability, dye saturation and resistance against degradation by ozone.

Tests

1. Color Density and Coordinates:

The color coordinate L*a*b of the printed samples were measured with a spectro-photometer Spectrolino® (available from Gretag Macbeth, Regensorf, Switzerland) in reflection mode (using CIE standard illuminant D65).

2. Stability Against Degradation by Ozone:

After measuring the optical density of the colored patches (see above), the printed samples were stored for 24, 48 and 96 hours in an ozone chamber, model 903 (available from Satra/Hamden, Great Britain) at a temperature of 30° C, a relative humidity of the air of 50% and an ozone concentration of 1 ppm at a velocity of the circulating, ozone containing air of 13 mm/s. After storage, the color density of the colored square patches of the samples were remeasured providing D_{∥}.

The percent of density loss of the dye in the colored patches due to ozone treatment is calculated according to the formula:

DL_{Ozone}=100%*(D_{|}−D_{∥})/D_{|}

High values of DL_{Ozone} indicate good ozone stability of a dye. Stability of a dye against degradation by ozone (indicate as DL_{Ozone}) was graduated in the following way:
A: less than 20% dye density loss
B: 20% to 40% dye density loss
C: more than 40% dye density loss

Results:

TABLE 2

| | | | | Dye concen- | |
|---|---|---|---|---|---|
| | | | | tration in | L*a*b*-values |
| Dye | DL_{Ozone} | DL_{Ozone} | OD | the recording | of printed patches |
| Nr. | 24 ppmh* | 48 ppmh* | max | liquid | (material 1) |
| 10A | A | A | 1.69 | 2.1% | 44.8/84.6/−25.8 |
| 10B | A | A | 1.61 | 2.1% | 43.3/78.7/−24.9 |
| 11A | A | A | 1.88 | 2.4% | 46.1/84.3/−14.8 |
| 11B | A | A | 2.04 | 3.5% | 42.3/82.8/−11.6 |
| 12A | A | A | 2.0 | 3.2% | 43.9/82.6/−10.3 |
| 12B | A | A | 2.04 | 3.3% | 44.0/84.1/−9.7 |
| 12C | A | A | 2.05 | 3.2% | 44.0/83.2/−9.5 |
| 13A | A | A | 1.73 | 2.5% | 45.5/84.0/−22.2 |
| 13B | A | A | 2.13 | 3.7% | 39.6/83.7/−17.8 |
| 14 | A | A | 1.66 | 2.3% | 44.2/82.0/−24.0 |
| 15 | A | A | 1.70 | 2.9% | 43.2/80.2/−25.2 |
| 16 | A | A | 1.65 | 2.37% | 41.25/79.8/−31.0 |
| 17 | A | A | 2.11 | 3.2% | 41.5/83.2/−10.7 |
| 18 | A | A | 2.18 | 2.8% | 39.0/83.0/−13.9 |
| 19 | A | A | 2.15 | 2.6% | 40/83.1/−13.6 |
| 20 | A | A | 2.13 | 2.7% | 43.9/83.8/−5.4 |
| (I) | A | A | 1.96 | 4.3% | 43.2/87.4/−25.5 |
| (II) | A | B | 2.12 | 2.5% | 47.7/86.2/−9.9 |

*ozone concentration: DL_{Ozone} after exposure to 24 ppmh and 48 ppmh

The L*a*b values for the printed samples on a inkjet paper are depicted in the last column of table 2, these values show the shade and gamut of the different dyes. The corresponding optical densities at 100% printed density are depicted as OD max in table 2 as well. These OD are directly relating to the concentration of the dye used in the formulation of the recording liquid.

The results in Table 2 immediately show that the dyes (10A), (10B), (11A), (11B), (12A), (12B), (12C), (13A), (13B), (14), (15) (16), (17), (18), (19) and (20) according to the invention have a considerably better stability against degradation by ozone than comparative example (II) (Magenta dye Bayscript® BB (Reactive red 141)).

Low dye contents in recording liquids are required to avoid clogging of the printing heads and for having better print performances. In that context the results in table 2 immediately show that in comparison to the dyes of the invention, 50% to 100% more dye material of the comparative example (I) is required to reach the same saturation represented as OD max in column 4. In addition to this, comparative example (I) presents a much more bluish shade as compounds 11A, 11B, 12A, 12B, 12C and 13B of the invention. Lower b* values are required to obtain pure red shades. Comparative example (I) cannot achieve such requirements.

1. An anthrapyridone azo dye of general formula (III): 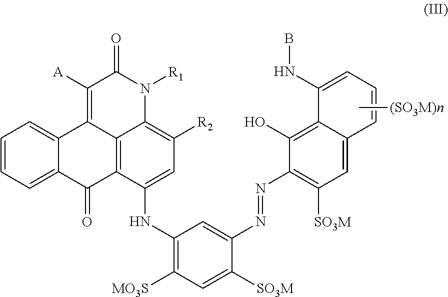
wherein
A represents a unsubstituted or substituted CO-phenyl group, where the substituents are selected from the group consisting of Cl, Br, OCH₃, SO₃M or represents a CO-thiophene group, a hydrogen atom, COOCH_{3,} COOCH₂CH_{3,} CN, or phenyl group;
R₁ represents a hydrogen atom or a unsubstituted or substituted alkyl group having from 1 to 8 carbon atoms where the substituents are selected from the group consisting of OH, SO₃M, COOM;
R₂ represents a hydrogen atom or SO₃M
B represents a unsubstituted or substituted CO-aliphatic group having from 1 to 6 carbon atoms where the substituents are selected from the group consisting of Cl, Br, SO₃M, COOM and phenyl;
or a unsubstituted or substituted CO-aromatic ring group where the substituents are selected from the group consisting of alkyl, alkoxy, Cl, Br, OH, COOM, CN, NO2, SO₃M and phenyl; or a CO-heterocyclic ring group;
or a substituted or unsubstituted SO₂⁻aliphatic group having from 1 to 6 carbon atoms; or SO₂⁻aromatic ring group where the substituents are selected from the group consisting of alkyl, alkoxy, Cl, Br, CN, NO₂, SO₃M and phenyl; or SO₂⁻ heterocyclic ring group;
or represents a moiety of formula C 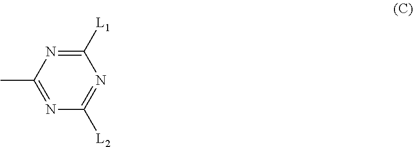
wherein L₁ and L₂ independently represents OH, Cl, alkoxy having from 1-6 carbon atoms, substituted thioalkyl having from 1-6 carbon atoms where the substituents are selected from the group consisting of OH, COOM and SO₃M; or NR₆R₇ where R₆R₇ independently represents H, substituents having from 1-6 carbon atoms where the substituents are selected from the group consisting of OH, COOM and SO₃M,
or represents a moiety of formula D 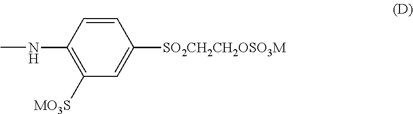
or represents a moiety of formula E, 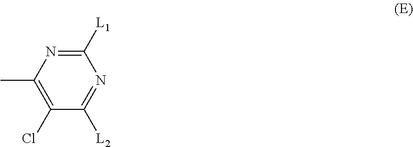
wherein L₁ and L₂ independently represents OH, Cl, alkoxy having from 1-6 carbon atoms, substituted thioalkyl having from 1-6 carbon atoms where the substituents are selected from the group consisting of OH, COOM and SO₃M; or NR₆R₇ where R₆R₇ independently represents H, substituents having from 1-6 carbon atoms where the substituents are selected from the group consisting of OH, COOM and SO₃M. and
M represents hydrogen, a metal cation or an ammonium cation, optionally substituted by one or more alkyl groups or substituted alkyl groups or hydroxyalkoxyalkyl groups each having from 1 to 18 carbon atoms. and
n is 0 or 1 and SO₃M is in position 3 or 4

2. The anthrapyridone azo dye of claim 1, wherein R₂ represents hydrogen.

3. The anthrapyridone azo dye of claim 2, wherein R₁ represents hydrogen or CH₃.

4. The aanthrapyridone azo dye of claim 3, wherein n is 1 and SO₃M is in position 3 or 4.

5. The anthrapyridone azo dyes according to claim 4, wherein n is 1 and SO₃M is in position 4.

6. The anthrapyridone azo dyes according to claim 5; wherein
B represents a unsubstituted or substituted CO-aliphatic group having from 1 to 6 carbon atoms where the substituents are selected from the group consisting of Cl, Br, SO₃M, COOM and phenyl;
or a unsubstituted or substituted CO-aromatic ring group where the substituents are selected from the group consisting of alkyl, alkoxy, Cl, Br, OH, COOM, CN, NO₂, SO₃M and phenyl; or a CO-heterocyclic ring group;
or a substituted or unsubstituted SO₂⁻aliphatic group having from 1 to 6 carbon atoms; or SO₂⁻aromatic ring group where the substituents are selected from the group consisting of alkyl, alkoxy, Cl, Br, CN, NO₂, SO₃M and phenyl; or SO₂⁻ heterocyclic ring group.

7. A method of preparing the anthrapyridone azo dyes according to claim 1:
a β-ketoester of general formula (IV), 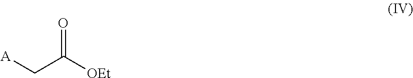
wherein A is as defined in claim 1,
is reacted with a compound of formula (V), 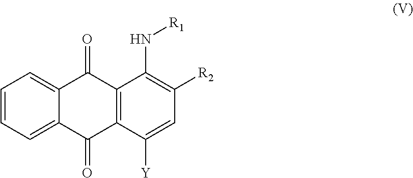
wherein R₁ and R₂ are defined as in claim 1 and Y represents chloro, bromo or another leaving group,
under conditions that form the anthrapyridone of formula (VI), 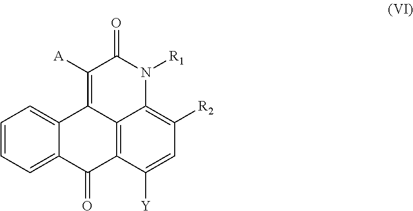
the anthrapyridone of general formula (VI), wherein A, R₁ and R₂ are defined as in claim 1, is subsequently reacted with m-phenylenediamine under conditions that form the anthrapyridone dye of general formula (VII), 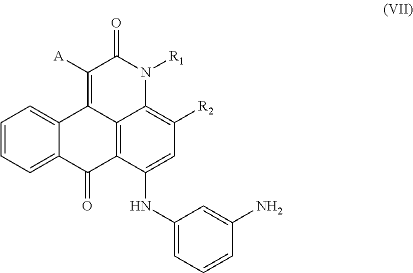
the anthrapyridone dye of general formula (VII), wherein A, R₁ and R₂ are defined as in claim 1, is reacted with sulfamic acid or oleum under conditions that form the anthrapyridone dye of general formula (VIII), 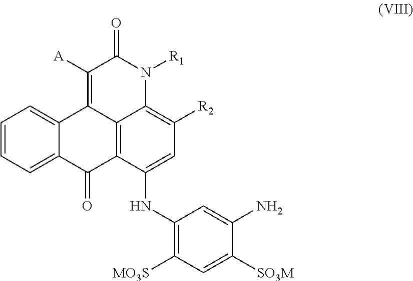
and is subsequently diazotized and coupled with a compound of general formula (IX), 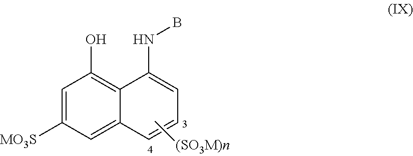
wherein M, B and n are defined as in claim 1,
under conditions that form the anthrapyridone azo dye of general formula (III).

8. A method for recording text and images on recording sheets and for dyeing and printing natural or synthetic fibre materials, nanoporous materials, textile, leather and aluminium by applying thereto an anthrapyridone azo dye according to claim 1.

9. A bliquid dye preparation comprising at least one anthrapyridone azo dye according to claim 1.

10. A liquid dye preparation according to claim 1 further comprising one or more other magenta dyes.

11. A recording liquid for inkjet printing comprising at least one anthrapyridone azo dye according to claim 1.

12. The recording liquid for inkjet printing according to claim 11, further comprising one or more magenta pigment dispersions (containing Pigment Red 122 or Pigment violet 19 or Pigment Red 202) or dyes as in patent EP 0,754,207, EP 1,219,682, EP 1,367,098 or EP 1,403,328, wherein an amount of said dyes in a liquid phase is in a range of from 0.5 to 20 wt.-% based on the total weight of the liquid phase.

13. The recording liquid according to the claim 11 wherein the liquid phase further comprises one or more of the following components: N-Methyl-2-pyrrolidone, 2-pyrrolidone, 2-hxylpyrrolidone, hydroxyethylpyrrolidone, 1,2-hexanediol, 1,2-butanediol, Trimethylolpropane, Diethylene glycol monobutylether, Triethylene glycol monobutylether, Dipropylene glycol monobutylether, glycerine, butyl lactate, caprolactam , sulfolane, glycolether solvents, or biocide in a range from 0.01 to 50 wt.-%, based on the total weight of the liquid phase.

14. A method for applying a liquid phase on a substrate comprising:
α) Providing a substrate, and
β) Providing a reservoir comprising the liquid phase according to claim 9,
γ) transferring at least a part of the liquid phase from the reservoir to the substrate, and
δ) Removing water, and optionally solvents, from the substrate.

15. A printed article comprising
A. a substrate, and
B. a layer comprising at least a dye of formula (III) according to claim 1.

16. A use of a dye according to claim 1 in inks for inkjet printing, writing utensil, or in dyeing solutions for manufacturing of color filters, colored objects, optical and opto-electronic applications.
